(19) United States
(12) Patent Application Publication
(10) Pub. No.: US 2005/0120566 A1
(43) Pub. Date: Jun. 9, 2005

(54) Scissors for medical Purposes

(75) Inventors: Manfred Dworschak, Duerbheim (DE); Theodor Lutze, Balgheim (DE); Pedro Morales, Tuttlingen-Nendingen (DE); Dieter Weisshaupt, Immendingen (DE)

Correspondence Address: Lipsitz & McAllister, LLC, 755 MAIN STREET, MONROE, CT, 06468, US

(73) Assignee: AESCULAP AG & Co. KG, Tuttlingen (DE)

(21) Appl. No.: 10/981,379

(22) Filed: Nov. 3, 2004

Related U.S. Application Data
(63) Continuation of application No. PCT/EP03/04378, filed on Apr. 26, 2003.

(30) Foreign Application Priority Data
May 7, 2002 (DE) 102 21 321.6

(51) Int. Cl. B26B 13/28

(52) U.S. Cl. 30/266

(57) ABSTRACT

In order to ensure in any case, in the case of scissors for medical purposes comprising two scissor parts which are pivotally mounted on one another at a joint and each comprise a scissor blade, that the scissor blades of the scissor parts abut on one another under tension during the closure movement, it is suggested that the two scissor parts or parts securely connected to them have biasing elements, that the biasing elements of the two scissor parts abut on one another during their movement relative to one another when the scissor parts are pivoted and that the biasing elements be shaped such that the two scissor parts pass during closure from a rest position, in which the two scissor blades are not or only slightly biased against one another in the direction of their pivot axis, into a biasing position, in which the two scissor blades are brought closer to one another in the direction of their pivot axis and are thereby biased against one another.

This application is a continuation of international application number PCT/EP03/04378 filed on Apr. 26, 2003.

The present disclosure relates to the subject matter disclosed in International application No. PCT/EP03/04378 of Apr. 26, 2003, which is incorporated herein by reference in its entirety and for all purposes.

### BACKGROUND OF THE INVENTION

The invention relates to scissors for medical purposes comprising two scissor parts pivotally mounted on one another at a joint and each comprising a scissor blade.

In the medicosurgical field, scissors are required to a large extent in order to cut tissue parts, suture material, dressing material etc. reliably. In this respect, it is extremely important for the cutting edges of the scissors to abut reliably on one another in the contact area of the cutting edges during the cutting procedure, namely as far as possible under tension.

In the case of conventional scissors consisting of metal, this can be achieved by means of a corresponding shaping of the scissor parts but difficulties result when the scissors are manufactured from plastics since the plastic materials normally display creeping properties, i.e., the material gives way when the parts are pressed against one another for a longer period of time. When such scissors are stored, there is, therefore, the risk of the material being deformed to such an extent that a reliable cutting procedure is no longer possible.

It is the object of the invention to design scissors of the generic type such that the scissor parts are always biased against one another reliably in the area of the scissor blades and abut on one another even when the scissors are stored for a longer period of time.

### SUMMARY OF THE INVENTION

This object is accomplished in accordance with the invention, in scissors of the type described at the outset, in that the two scissor parts or parts securely connected to them have biasing elements, that the biasing elements of the two scissor parts abut on one another during their movement relative to one another when the scissor parts are pivoted and that the biasing elements are shaped such that during closure the two scissor parts pass from a rest position, in which the two scissor blades are not biased or only slightly against one another in the direction of their pivot axis, into a biasing position, in which the two scissor blades are brought closer to one another in the direction of their pivot axis and are thereby biased against one another.

As a result of this configuration, care is taken that the scissor parts of the scissors are not or only slightly biased against one another in their opened position and so there is no risk of any deformation taking place due to creeping of the material. On the other hand, care is taken during closure of the scissor parts by means of the biasing elements that the two scissor parts are biased against one another in the direction of the bearing shaft and this automatically leads to the scissor blades being biased against one another; therefore, in the area of abutment of the scissor blades these always slide along one another reliably and under tension so that a faultless cutting procedure is ensured. It is advantageous to store such scissors with opened scissor parts; as a result, it is ensured that no undesired deformation occurs even in the case of a creeping material; during use, the scissor parts are then pivoted into the closed position and made operable by means of the biasing elements described by being biased against one another.

It is advantageous when the biasing elements comprise a web-like supporting surface which is inclined in relation to a plane of pivoting extending at right angles to the pivot axis, and a path follower abutting thereon. As a result, the biasing against one another of the two scissor parts or scissor blades is ensured solely by the pivoting movement of the scissor parts, the path follower moves along the inclined supporting surface abutting on it and the scissor parts are biased against one another in the direction of the bearing shaft during closure as a result of the inclination of the supporting surface.

In this respect, it is particularly favorable when the path follower is of a convex design so that it abuts on the supporting surface in a punctiform or linear manner. This convex shape may be in the form of a cylinder surface but also in the form of a partial spherical surface; in the case of a cylinder surface, a linear abutment essentially results, in the case of a spherical design a punctiform abutment on the supporting surface.

The biasing elements are preferably arranged in the area of the joint.

In a preferred embodiment it is provided for the path-like supporting surface to be arranged at the edge of a bearing opening of one scissor part and the path follower on a bearing shaft of the other scissor part passing through this bearing opening.

However, the opposite arrangement is, in principle, also possible; the path follower is then arranged at the edge of a bearing opening of one scissor part and the web-like supporting surface on a bearing shaft of the other scissor part passing through this bearing opening.

A particularly preferred embodiment results when it is provided for one scissor part to have a non-circular bearing opening, through which a bearing shaft of the other scissor part projects, for the bearing shaft to bear at its end facing away from the other scissor part a head-like non-circular enlarged portion which passes through the non-circular bearing opening when the scissor parts are opened and which covers the edge of the bearing opening with its underside when the scissor parts are pivoted in the closing direction and thereby prevents the bearing shaft from sliding out of the bearing opening. The bearing shaft and the bearing opening therefore form a bayonet locking means which allows introduction of the bearing shaft into the bearing opening in a specific angular position but not in other angular positions.

In this respect, it is particularly favorable when the edge of the bearing opening and the underside of the enlarged portion form the two biasing elements.

Preferably, a respective two web-like supporting surfaces and path followers located diametrically opposite one another can be arranged at the bearing opening and on the bearing shaft, respectively, or a respective two web-like supporting surfaces and path followers located diametrically opposite one another can be arranged on the bearing shaft and at the bearing opening, respectively, so that the forces biasing the two scissor parts against one another engage symmetrically on both sides of the joint and any jamming of the two scissor parts is prevented as a result.

The inclination of the web-like supporting surface in relation to the plane of pivoting can, for example, be between ½° and 3°, i.e., relatively small inclinations are sufficient to generate the desired pretensioning during the closure movement.

In a particularly preferred embodiment it is provided, in addition, for the bearing opening and/or the bearing shaft to bear elastic detent elements which facilitate an insertion of the bearing shaft into the bearing opening when the scissor parts are opened as a result of elastic deformation but prevent or make more difficult any withdrawal of the bearing shaft out of the bearing opening when the elastic tension in them is released after the insertion of the bearing shaft into the bearing opening. In other words, a snap connection results in the longitudinal direction of the bearing shaft and so even when the scissor parts are opened the scissor parts are prevented from falling apart again after being put together. In the opened position, the enlarged portion just passes through the non-circular bearing opening, without the snap connection the two scissor parts could therefore become detached from one another again inadvertently.

It is favorable when the detent elements are designed as lateral projections on the enlarged portion of the bearing shaft. The projections preferably bear lateral sliding surfaces which are adjoined by a shoulder. The sliding surfaces facilitate the insertion of the bearing shaft into the opening; as soon as the bearing shaft has been pushed completely into the bearing opening, the tension in the detent elements can be released again; the edge of the bearing opening then engages on the shoulder and prevents or makes more difficult any withdrawal of the bearing shaft out of the bearing opening.

As a result of the biasing elements described, the two scissor parts are biased against one another during their closure such that the scissor blades of the scissor parts are biased against one another in their contact area.

The biasing in the cutting area may be increased, in addition, in that at least one of the two scissor parts is of an elastic design in the area of its scissor blade and that at least one of the two scissor parts is bent out of the plane of pivoting. The two scissor parts are, as a result, also biased forcefully against one another in the contact area, namely this biasing against one another results due to the different curvatures of the scissor blades, for example, one may be straight and one curved, and due to the elastic deformation of at least one of the two scissor parts during closure. This effect assists the effect of the biasing together which is generated by the biasing elements during closure.

This biasing in the cutting area can also be increased in that the scissor parts are of an elastic design in the area of their scissor blades and are bent out of the plane of pivoting and that the radius of bend of the inner scissor part is greater than that of the outer scissor part, in particular, the radius of bend of the inner scissor part is 10 to 30% greater than that of the outer scissor part. The outer scissor part and the inner scissor part are likewise biased forcefully against one another in the contact area as a result, namely this biasing against one another results due to the different radii and the elastic deformation of the two scissor parts during closure. This effect assists the effect of the biasing together which is generated by the biasing elements during closure.

The following description of preferred embodiments of the invention serves to explain the invention in greater detail in conjunction with the drawings.

### BRIEF DESCRIPTION OF THE DRAWINGS

FIG. 1: shows scissors with the two scissor parts in the opened position;

FIG. 2: shows a sectional view along line 2-2 in FIG. 1;

FIG. 3: shows a plan view of the joint area of the scissors of FIG. 1 with scissor parts in an opened position;

FIG. 4: shows a plan view of the front area of the scissors of FIG. 1 with the scissor parts in a closed position;

FIG. 5: shows a view similar to FIG. 3 with the two scissor parts in a closed position;

FIG. 6: shows a sectional view along line 6-6 in FIG. 5 and

FIG. 7: shows a side view of the two scissor parts of the scissors of FIG. 1.

### DETAILED DESCRIPTION OF THE INVENTION

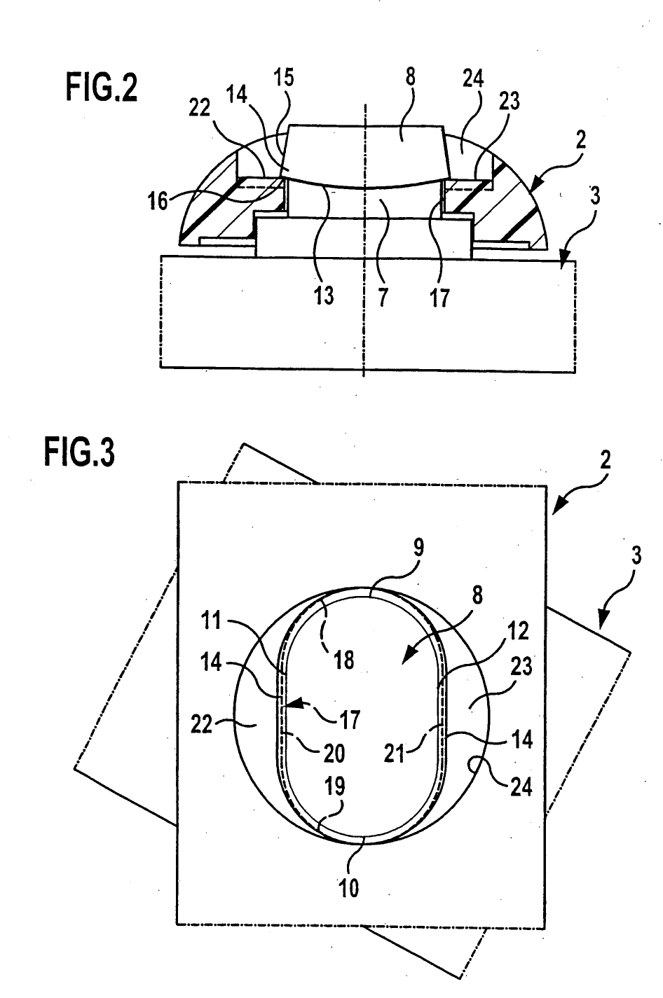

The scissors 1 shown in the drawings comprise two scissor parts 2, 3 each with a scissor blade 4 forming a cutting edge, a bearing area 5 and a gripping part 6. In the bearing area 5, the two scissor parts 2 and 3 are pivotally connected to one another. For this purpose, a male scissor part 3 bears a bearing shaft 7 which projects from it and is provided at its free end with a head-like enlarged portion 8. This is of an essentially oval design in the embodiment illustrated, i.e., the enlarged portion 8 has at oppositely located ends end sections 9, 10 which are in the shape of circular arcs and each extend over 180° and these end sections 9, 10 are connected to one another by straight sections 11, 12 (FIGS. 3 and 5). The two straight sections 11 and 12 have a distance between them which corresponds approximately to the diameter of the bearing shaft 7, the end sections 9, 10 in the shape of circular arcs project, on the other hand, beyond the cross section of the bearing shaft 7. Their underside 13 is curved downwards like a barrel or a circular cylinder; the longitudinal axis of this curvature coincides with the longitudinal axis of the enlarged portion 8 (FIG. 2).

Respective detent projections 14 are arranged on the two straight sections 11, 12; these detent projections project slightly beyond the cross section of the bearing shaft 7 and have a sliding surface 15 ascending at an angle in the direction towards the scissor part 3 from the free end of the bearing shaft 7 and a shoulder 16 adjoining this surface; the shoulder is formed by the underside 13 which extends as far as the sliding surface 15 (FIG. 2).

In the other, the so-called female scissor part 2, a continuous bearing opening 17 is arranged in the bearing area 5, the cross section of this opening corresponding essentially to the cross section of the enlarged portion 8 of the bearing shaft 7; it likewise has two end sections 18, 19 in the shape of circular arcs which respectively extend over 180° and are connected to one another by straight sections 20, 21. The dimensions of the bearing opening 17 are selected such that the enlarged portion 8 passes through the bearing opening 17 when the longitudinal axes of the bearing opening 17 and the enlarged portion 8 are aligned with one another; however, the detent projections 14 are pressed together elastically during the insertion and the tension in them can be released again only when the bearing shaft 7 has been pushed completely into the bearing opening 17; the detent projections 14 then engage over the straight sections 20, 21 of the bearing opening 17 and prevent the bearing shaft 7 from being withdrawn from the bearing opening 17; any withdrawal is then no longer possible or only by overcoming a specific holding force. This is, therefore, a snap connection which is effective at the end of the pushing together.

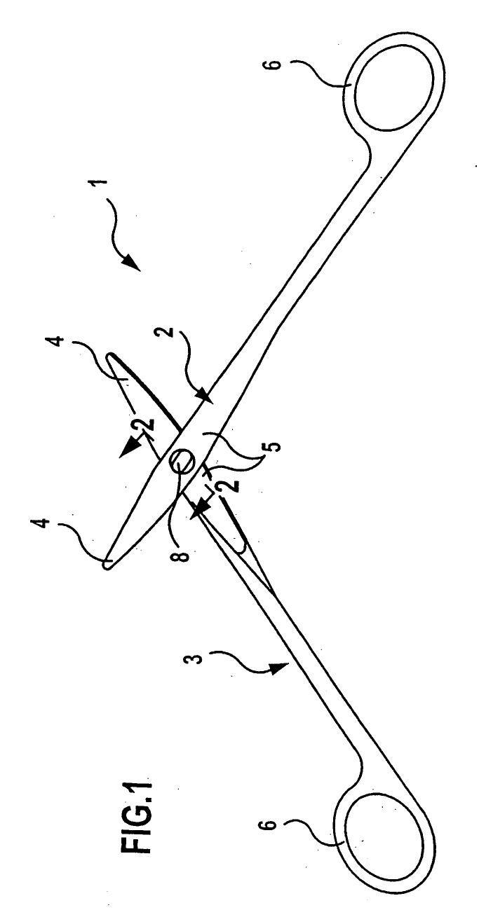

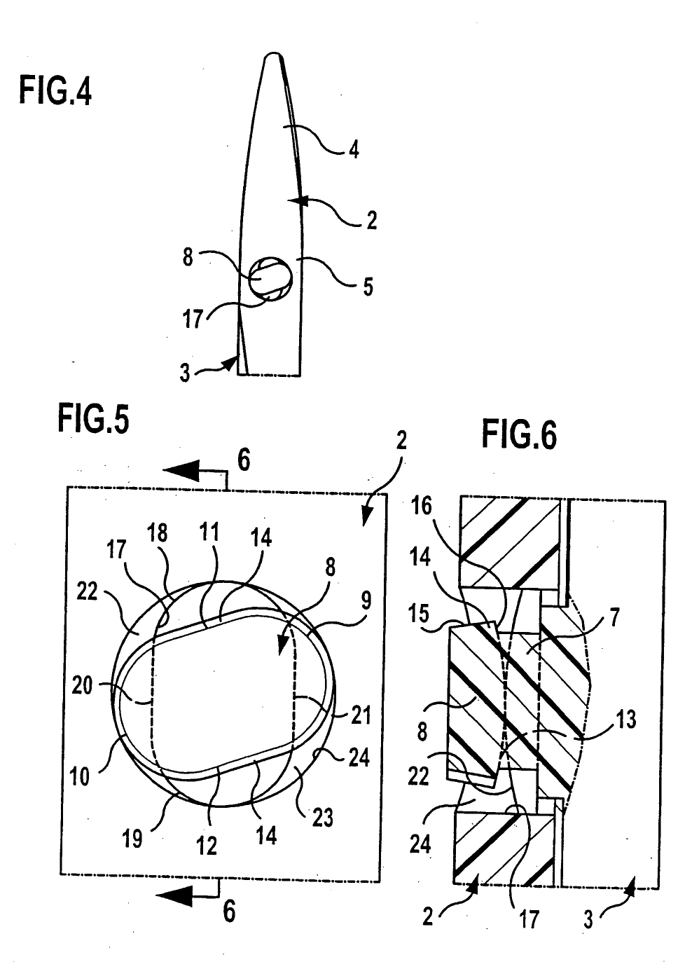

The bearing shaft 7 with the enlarged portion 8 and the bearing opening 17 are arranged relative to one another such that the enlarged portion 8 can be pushed through the bearing opening 17 when the two scissor parts 2, 3 are opened wide, as illustrated in FIG. 1. When the two scissor parts 2, 3 are pivoted into a closed position, the underside 13 of the enlarged portion 8 slides along two supporting surfaces 22, 23 which encircle the bearing opening 17 in a sickle shape immediately adjoining its straight sections 20, 21 so that any withdrawal of the bearing shaft 7 out of the bearing opening 17 is reliably prevented as a result; this represents a bayonet locking mechanism of the two scissor parts which facilitates pivoting of the two scissor parts as far as the complete closed position, in which the two scissor parts are essentially parallel to one another (FIG. 4).

The supporting surfaces 22 and 23 are, in the embodiment illustrated in the drawings, arranged on the base of a circular recess 24 in the scissor part 2; this recess 24 surrounds the bearing opening 17 concentrically.

The supporting surfaces 22 and 23 are slightly inclined in relation to a plane, which is at right angles to the pivot axis of the two scissor parts and is designated in the following as plane of pivoting, namely in such a manner that the scissor parts 2, 3 are increasingly biased against one another during their pivoting out of the opened position illustrated in FIG. 1 into the closed position. During this closing movement, the undersides 13 of the enlarged portion 8 slide along the supporting surfaces 22, 23; the supporting surfaces 22 and 23 can, in this respect, be designed so as to rise continuously over an angle of 180° but it is also possible, as illustrated in FIG. 6, for the supporting surfaces 22 and 23 to have an ascending and then again a descending area which is designed to be at the highest in that area, in which the underside 13 abuts on the supporting surface 22 and 23 in the closed position of the two scissor parts.

The inclination of the supporting surfaces can be relatively slight, for example, it can be in the range between ½° and 3°; in FIG. 6, this inclination is illustrated excessively only for reasons of clarity.

It is ensured by means of the convex design of the underside 13 that the underside 13 abuts in a linear manner on the supporting surface 22 or 23 over the entire pivoting range; an exactly defined coordination is, therefore, ensured.

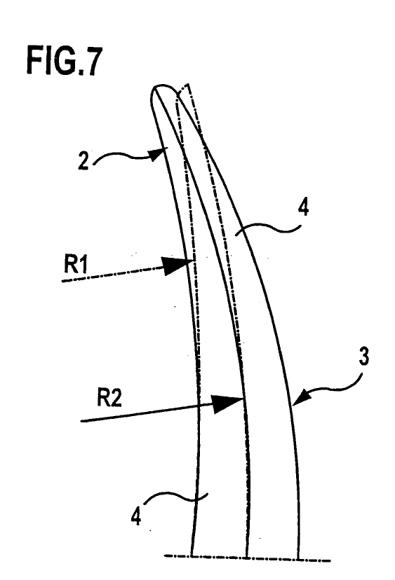

The scissor blades 4 of the two scissor parts 2 and 3 are both bent out of the plane of pivoting, as is apparent from the illustration of FIG. 7. The inner scissor part 2 is bent with a radius of curvature R1, the outer scissor part 3 with a radius of curvature R2. In this respect, the radius of curvature R1 is greater than the radius of curvature R2, namely by approximately 10 to 30%. This results in the inner scissor part being supported on the outer scissor part during the closure movement; both scissor parts are, in this respect, deformed such that they are biased forcefully against one another in the area of abutment, i.e., in the area of the scissor blades. In FIG. 7, the course of the non-deformed inner scissor part 2 is illustrated by dash-dot lines for the purpose of clarity; due to its abutment on the outer scissor part 3, this scissor part is deformed such that its course is that illustrated by solid lines and as a result of this deformation, both scissor parts 2, 3 are reliably biased elastically against one another; this additional biasing of the scissor parts is superimposed on the biasing which is generated during the closure movement of the scissor parts due to the fact that the underside 13 is guided so as to abut on the ascending supporting surfaces 22, 23 and, as a result, the two scissor parts 2, 3 are biased against one another in the bearing area 5.

The scissors illustrated in the drawings are preferably produced from a sterilizable plastic material which has an intrinsic elasticity, for example, from a plastic material which can be sterilized by radiation, gas or steam, in particular, from a plastic material which can be subjected to gamma or ETO (ethylene oxide) sterilization, such as, for example, PPA (polyphenylamide). The configuration described also enables the use of plastic materials which display a long-term creeping. These scissors are preferably stored in the opened position illustrated in FIG. 1 and not pivoted into the closed position until they are used so that it is ensured that the two scissor parts are not biased against one another until they are used. In this short period of use, no deformations result due to undesired creeping of the plastic material; this could occur, at the most, when the scissors have been stored in the closed position for a long period of time and this can be avoided by the storage in the opened position as described.

1. Scissors for medical purposes comprising two scissor parts pivotally mounted on one another at a joint and each comprising a scissor blade, wherein the two scissor parts or parts securely connected to them have biasing elements, said elements abutting on one another during their movement relative to one another when the scissor parts are pivoted and being shaped such that during closure the two scissor parts pass from a rest position, the two scissor blades not being biased or only slightly against one another in the direction of the pivot axis in said rest position, into a biasing position, the two scissor blades being brought closer to one another in the direction of their pivot axis and thereby being biased against one another in said biasing position, wherein the biasing elements comprise a web-like supporting surface inclined in relation to a plane of pivoting extending at right angles to the pivot axis and a path follower abutting thereon, wherein the web-like supporting surface is arranged at the edge of a bearing opening of one scissor part and the path follower on a bearing shaft of the other scissor part passing through this bearing opening.

2. Scissors as defined in claim 1, wherein the path follower is of a convex design so that it abuts on the supporting surface in a punctiform or linear manner.

3. Scissors as defined in claim 1, wherein one scissor part has a non-circular bearing opening, a bearing shaft of the other scissor part projecting through said opening, wherein the bearing shaft bears a head-shaped, non-circular enlarged portion at its end facing away from the other scissor part, said enlarged portion passing through the non-circular bearing opening when the scissor parts are open and covering the edge of the bearing opening with its underside when the scissor parts are pivoted in the closing direction and thereby preventing the bearing shaft from sliding out of the bearing opening.

4. Scissors as defined in claim 2, wherein one scissor part has a non-circular bearing opening, a bearing shaft of the other scissor part projecting through said opening, wherein the bearing shaft bears a head-like, non-circular enlarged portion at its end facing away from the other scissor part, said enlarged portion passing through the non-circular bearing opening when the scissor parts are open and covering the edge of the bearing opening with its underside when the scissor parts are pivoted in the closing direction and thereby preventing the bearing shaft from sliding out of the bearing opening.

5. Scissors as defined in claim 3, wherein the edge of the bearing opening and the underside of the enlarged portion form the two biasing elements.

6. Scissors as defined in claim 3, wherein a respective two path-like supporting surfaces and path followers located diametrically opposite one another are arranged at the bearing opening and on the bearing shaft, respectively, or a respective two path-like supporting surfaces and path followers located diametrically opposite one another are arranged on the bearing shaft and at the bearing opening, respectively.

7. Scissors as defined in claim 1, wherein the inclination of the path-like supporting surface in relation to the plane of pivoting is between ½° and 3°.

8. Scissors as defined in claim 3, wherein the bearing opening and/or the bearing shaft bear elastic detent elements facilitating insertion of the bearing shaft into the bearing opening when the scissor parts are open due to elastic deformation but preventing or making more difficult any withdrawal of the bearing shaft out of the bearing opening when the elastic tension in them is released after the insertion of the bearing shaft into the bearing opening.

9. Scissors as defined in claim 8, wherein the detent elements are designed as lateral projections on the enlarged portion of the bearing shaft.

10. Scissors as defined in claim 9, wherein the projections bear lateral sliding surfaces, a shoulder adjoining said surfaces.

11. Scissors as defined in claim 1, wherein at least one of the two scissor parts is of an elastic design in the area of its scissor blade and wherein at least one of the two scissor parts is bent out of the plane of pivoting.

12. Scissors as defined in claim 11, wherein the scissor parts are of an elastic design in the area of their scissor blades and are bent out of the plane of pivoting and wherein the radius of bend of the inner scissor part is greater than that of the outer scissor part.

13. Scissors as defined in claim 11, wherein the radius of bend of the inner scissor part is 10 to 30% greater than that of the outer scissor part.

14. Scissors for medical purposes comprising two scissor parts pivotally mounted on one another at a joint and each comprising a scissor blade, wherein the two scissor parts or parts securely connected to them have biasing elements, said elements abutting on one another during their movement relative to one another when the scissor parts are pivoted and being shaped such that during closure the two scissor parts pass from a rest position, the two scissor blades not being biased or only slightly against one another in the direction of the pivot axis in said rest position, into a biasing position, the two scissor blades being brought closer to one another in the direction of their pivot axis and thereby being biased against one another in said biasing position, wherein the biasing elements comprise a web-like supporting surface inclined in relation to a plane of pivoting extending at right angles to the pivot axis and a path follower abutting thereon, wherein the path follower is arranged at the edge of a bearing opening of one scissor part and the path-like supporting surface on a bearing shaft of the other scissor part passing through this bearing opening.

15. Scissors as defined in claim 14, wherein the path follower is of a convex design so that it abuts on the supporting surface in a punctiform or linear manner.

16. Scissors as defined in claim 14, wherein one scissor part has a non-circular bearing opening, a bearing shaft of the other scissor part projecting through said opening, wherein the bearing shaft bears a head-shaped, non-circular enlarged portion at its end facing away from the other scissor part, said enlarged portion passing through the non-circular bearing opening when the scissor parts are open and covering the edge of the bearing opening with its underside when the scissor parts are pivoted in the closing direction and thereby preventing the bearing shaft from sliding out of the bearing opening.

17. Scissors as defined in claim 15, wherein one scissor part has a non-circular bearing opening, a bearing shaft of the other scissor part projecting through said opening, wherein the bearing shaft bears a head-like, non-circular enlarged portion at its end facing away from the other scissor part, said enlarged portion passing through the non-circular bearing opening when the scissor parts are open and covering the edge of the bearing opening with its underside when the scissor parts are pivoted in the closing direction and thereby preventing the bearing shaft from sliding out of the bearing opening.

18. Scissors as defined in claim 16, wherein the edge of the bearing opening and the underside of the enlarged portion form the two biasing elements.

19. Scissors as defined in claim 16, wherein a respective two path-like supporting surfaces and path followers located diametrically opposite one another are arranged at the bearing opening and on the bearing shaft, respectively, or a respective two path-like supporting surfaces and path followers located diametrically opposite one another are arranged on the bearing shaft and at the bearing opening, respectively.

20. Scissors as defined in claim 14, wherein the inclination of the path-like supporting surface in relation to the plane of pivoting is between ½° and 3°.

21. Scissors as defined in claim 16, wherein the bearing opening and/or the bearing shaft bear elastic detent elements facilitating insertion of the bearing shaft into the bearing opening when the scissor parts are open due to elastic deformation but preventing or making more difficult any withdrawal of the bearing shaft out of the bearing opening when the elastic tension in them is released after the insertion of the bearing shaft into the bearing opening.

22. Scissors as defined in claim 21, wherein the detent elements are designed as lateral projections on the enlarged portion of the bearing shaft.

23. Scissors as defined in claim 22, wherein the projections bear lateral sliding surfaces, a shoulder adjoining said surfaces.

24. Scissors as defined in claim 14, wherein at least one of the two scissor parts is of an elastic design in the area of its scissor blade and wherein at least one of the two scissor parts is bent out of the plane of pivoting.

25. Scissors as defined in claim 24, wherein the scissor parts are of an elastic design in the area of their scissor blades and are bent out of the plane of pivoting and wherein the radius of bend of the inner scissor part is greater than that of the outer scissor part.

26. Scissors as defined in claim 24, wherein the radius of bend of the inner scissor part is 10 to 30% greater than that of the outer scissor part.
